(19) United States
(12) Patent Application Publication
(10) Pub. No.: US 2014/0358314 A1
(43) Pub. Date: Dec. 4, 2014

(54) POWER CONTROL UNIT AND PROGRAM

(71) Applicant: Yoichiro Sako, Tokyo (JP)

(72) Inventor: Yoichiro Sako, Tokyo (JP)

(73) Assignee: Sony Corporation, Tokyo (JP)

(21) Appl. No.: 14/346,396

(22) PCT Filed: Sep. 6, 2012
(86) PCT No.: PCT/JP2012/072721

§ 371 Date: Mar. 21, 2014

(30) Foreign Application Priority Data
Oct. 13, 2011 (JP) 2011-226006

(51) Int. Cl. G05F 1/66; G05B 15/02

(52) U.S. Cl. CPC G05F 1/66; G05B 15/02
USPC 700/297

(57) ABSTRACT

Provided is a power control unit including a receiving unit that receives information about commercial power, and a control unit that controls use of power generated by private power generation and use of the commercial power in accordance with the information received by the receiving unit.

### TECHNICAL FIELD

The present disclosure relates to a power control unit and a program.

### BACKGROUND ART

The power supply by commercial power companies is limited and in peak hours of electric power demand, the electric power demand may come close to the power supply. Therefore, power saving activities for reducing the electric power demand are widely performed.

Concerning power saving, Patent Literature 1 discloses a system that promotes power saving by monitoring power consumption in each household. Patent Literature 2 discloses a photovoltaic power generating system having a display means for conveying power conditions in the household to the user. Patent Literature 3 discloses a system to reduce power consumption of electrical apparatuses in peak hours.

### CITATION LIST

### Patent Literature

Patent Literature 1: JP 2002-312575A

Patent Literature 2: JP 2004-12376A

Patent Literature 3: JP 2010-98860A

### SUMMARY OF INVENTION

### Technical Problem

However, while a system to smooth power demand of individual regions of a household, an office and the like is available, no system to smooth power demand in a wider area (for example, the power supply range of a commercial power company) by using private power generation is known.

Thus, the present disclosure proposes a novel and improved power control unit capable of appropriately controlling the use of commercial power and the use of power by private power generation and a program.

### Solution to Problem

According to the present disclosure, there is provided a power control unit including a receiving unit that receives information about commercial power, and a control unit that controls use of power generated by private power generation and use of the commercial power in accordance with the information received by the receiving unit.

According to the present disclosure, there is provided a program causing a computer to function as a receiving unit that receives information about commercial power and a control unit that controls use of power generated by private power generation and use of the commercial power in accordance with the information received by the receiving unit.

### Advantageous Effects of Invention

According to the present disclosure described above, the use of commercial power and the use of power by private power generation can appropriately be controlled.

### BRIEF DESCRIPTION OF DRAWINGS

FIG. 1 is an explanatory view showing a configuration of a power control system according to an embodiment of the present disclosure.

FIG. 2 is an explanatory view showing a concrete example of demand forecasting information.

FIG. 3 is a function block diagram showing the configuration of a power control unit according to a first embodiment.

FIG. 4 is a flow chart showing an operation of the power control unit according to the first embodiment.

FIG. 5 is a function block diagram showing the configuration of a power control unit according to a second embodiment.

FIG. 6 is an explanatory view showing changes of remaining power of an accumulator.

FIG. 7 is an explanatory view showing changes of remaining power of the accumulator.

FIG. 8 is a flow chart showing the operation of the power control unit according to the second embodiment.

### DESCRIPTION OF EMBODIMENTS

Hereinafter, preferred embodiments of the present disclosure will be described in detail with reference to the appended drawings. Note that, in this specification and the drawings, elements that have substantially the same function and structure are denoted with the same reference signs, and repeated explanation is omitted.

Also in the present specification and drawings, a plurality of structural elements having substantially the same functional configuration may be distinguished by attaching different alphabets after the same sign. For example, a plurality of configurations having substantially the same functional configuration is distinguished like electrical apparatuses 50A, 50B, and 50C when necessary. However, if it is not necessary to specifically distinguish each of a plurality of configurations having substantially the same functional configuration, only the same sign is attached. For example, if it is not necessary to specifically distinguish the electrical apparatuses 50A, 50B, and 50C, the electrical apparatuses are simply called the electrical apparatuses 50.

The present disclosure will be described according to the order of items shown below.
1. Configuration of Power Control System
2. First Embodiment
2-1. Configuration of Power Control Unit According to First Embodiment
2-2. Operation of Power Control Unit According to First Embodiment
3. Second Embodiment
3-1. Configuration of Power Control Unit According to Second Embodiment
3-2. Operation of Power Control Unit According to Second Embodiment
4. Summary

### 1. Configuration of Power Control System

The technology according to the present disclosure can be embodied, as will be described in detail in “2. First Embodiment” to “3. Second Embodiment” as examples, in a variety of forms. A power control unit (20) according to each embodiment includes
A. a receiving unit (a communication unit 228) that receives information about commercial power and
B. a control unit (power controllers 244, 246) that controls the use of power by private power generation and the use of commercial power in accordance with information received by the receiving unit.

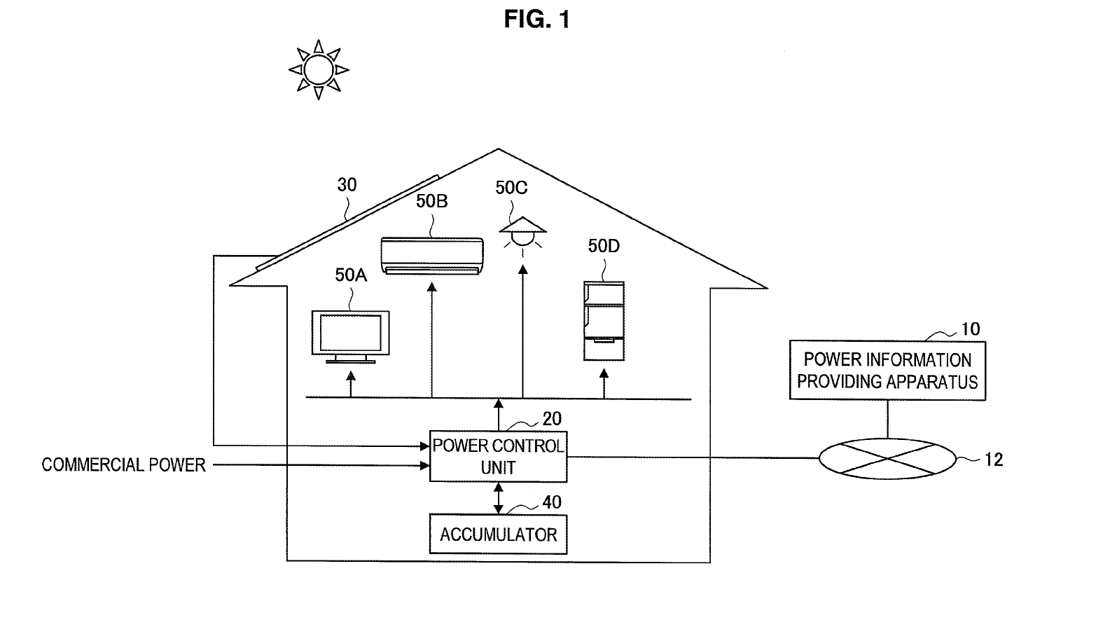

First, a power control system containing such a power control unit will be described below with reference to FIG. 1.

FIG. 1 is an explanatory view showing the configuration of a power control system according to an embodiment of the present disclosure. As shown in FIG. 1, a power control system according to an embodiment of the present disclosure includes a power information providing apparatus 10, a power control unit 20, a private power generating apparatus 30, an accumulator 40, and electrical apparatuses 50A to 50D.

The power information providing apparatus 10 and the power control unit 20 are connected, as shown in FIG. 1, via a communication network 12. The communication network 12 is a wire or wireless transmission line of information transmitted from an apparatus connected to the communication network 12. The communication network 12 may include, for example, a public network such as the Internet, a telephone network, and a satellite communication network and various kinds of LAN (Local Area Network) including Ethernet (registered trademark) or WAN (Wide Area Network). In addition, the communication network 12 may include a private network such as IP-VPN (Internet Protocol-Virtual Private Network).

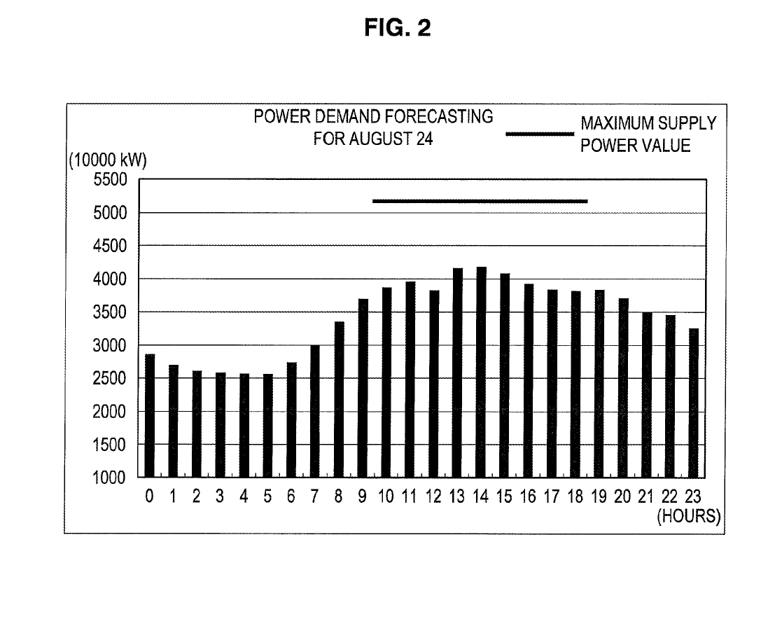

The power information providing apparatus 10 provides commercial power information about commercial power. The commercial power information may contain, for example, information indicating the current demand of commercial power, demand forecasting information indicating the demand of commercial power, or statistical information indicating past demands of commercial power. As an example of the commercial power information, the demand forecasting information will be described more concretely below with reference to FIG. 2.

FIG. 2 is an explanatory view showing a concrete example of the demand forecasting information. As shown in FIG. 2, the demand forecasting information contains information indicating the predicted value of demand of commercial power for each time zone and the maximum supply power value. A power user like an ordinary household or an office can perform power saving activities by grasping critical situations of demand of commercial power based on the demand forecasting information. The demand forecasting information may contain information indicating forecasting of the peak time zone of demand of commercial power.

The commercial power information may also contain alarm information issued when the demand of commercial power exceeds predetermined criteria. For example, when the ratio of power demand to the maximum supply power value exceeds or is expected to exceed a predetermined value (for example, 90%), the power information providing apparatus 10 may issue alarm information like a power saving advisory. A plurality of levels of alarm information may be provided in accordance with the degree of urgency or degree of tightness of power supply. As alarm information, for example, a power saving emergency warning, a power saving warning, a power saving advisory and the like can be assumed in descending order of degree of urgency or degree of tightness.

The power information providing apparatus 10 providing such commercial power information may be an apparatus managed by a power supply company providing commercial power.

The private power generating apparatus 30 is an apparatus to generate power (private power generation) on the side of the power user. While a photovoltaic power generator is shown in FIG. 1 as an example of the private power generating apparatus 30, the private power generating apparatus 30 is not limited to the photovoltaic power generator. For example, the private power generating apparatus 30 may be a fuel cell or a wind turbine generator. The privately generated power generated by the private power generating apparatus 30 is supplied to the power control unit 20.

The accumulator 40 is a secondary battery that can repeatedly be used by charging. For example, the accumulator 40 accumulates privately generated power supplied under the control of the power control unit 20. Power accumulated in the accumulator 40 is supplied to the electrical apparatuses 50A to 50D under the control of the power control unit 20.

The electrical apparatus 50 is an apparatus using electric power as the power source and the types of the electrical apparatus 50 range widely. In FIG. 1, for example, a display apparatus is shown as the electrical apparatus 50A, an air conditioner is shown as the electrical apparatus 50B, an illuminating apparatus is shown as the electrical apparatus 50C, and a refrigerator is shown as the electrical apparatus 50D. In summer, among the electrical apparatuses 50, power consumption of the air conditioner and the refrigerator increases in the daytime and thus, peak hours of power demand are often in the daytime. In winter, on the other hand, power consumption of the air conditioner increases in the nighttime and thus, peak hours of power demand are often in the nighttime.

The power control unit 20 receives the aforementioned commercial power information from the power information providing apparatus 10. The power control unit 20 has commercial power and privately generated power supplied thereto to control the use of power in a section like the household or enterprise based on commercial power information. For example, the power control unit 20 controls the use of privately generated power and power by private power generation like power of the accumulator 40, the user of commercial power, and the accumulation in the accumulator 40 based on commercial power information. Hereinafter, the first and second embodiments of the power control unit will in turn be described in detail.

### 2. First Embodiment

According to the first embodiment of the present disclosure, tightness of power demand with respect to the maximum supply power can be mitigated by appropriately controlling the use of privately generated power and the accumulation of power in the accumulator 40 based on commercial power information. The configuration and operation of a power control unit 20-1 according to the first embodiment of the present disclosure will be described in detail below.

### 2-1. Configuration of Power Control Unit According to First Embodiment

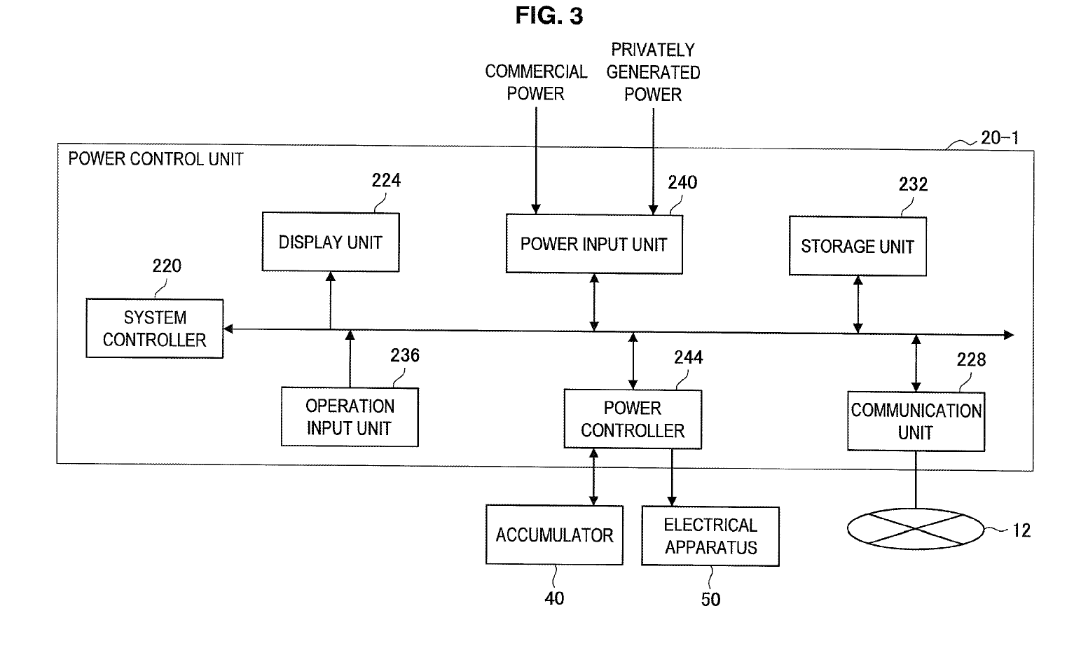

FIG. 3 is a function block diagram showing the configuration of the power control unit 20-1 according to the first embodiment. As shown in FIG. 3, the power control unit 20-1 according to the first embodiment includes a system controller 220, a display unit 224, the communication unit 228, a storage unit 232, an operation input unit 236, a power input unit 240, and the power controller 244.

### System Controller

The system controller 220 is formed of, for example, a CPU (Central Processing Unit), a ROM (Read Only Memory), a RAM (Random Access Memory) and the like to control the overall operation of the power control unit 20-1. While the power controller 244 is shown in FIG. 3 as a separate unit from the system controller 220, the function of the power controller 244 may be realized by the system controller 220.

### Display Unit

The display unit 224 drives a pixel driving circuit based on control of the system controller 220 to display an image. For example, the display unit 224 may display an image indicating commercial power information received by the communication unit 228, an image indicating remaining power of the accumulator 40, or an image indicating the usage of power in a household.

### Communication Unit

The communication unit 228 is an interface to an external device and communicates with the external device wirelessly or by wire. For example, the communication unit 228 can receive commercial power information from the power information providing apparatus 10 via the communication network 12. As the communication method of the communication unit 228, for example, wireless LAN (Local Area Network) and LTE (Long Term Evolution) can be cited.

### Storage Unit

The storage unit 232 is used to store various kinds of data. For example, the storage unit 232 may store a power control knowledge DB referred to by the power controller 244 for power control. The storage unit 232 may include a storage medium like a nonvolatile memory, a magnetic disk, an optical disk, or an MO (Magneto Optical) disk. The nonvolatile memory includes, for example, a flash memory, an SD card, a micro SD card, a USB memory, EEPROM (Electrically Erasable Programmable Read-Only Memory), and EPROM (Erasable Programmable ROM). The magnetic disk includes a hard disk and a disc-shaped magnetic disk. The optical disk includes CD (Compact Disc), DVD (Digital Versatile Disc), and BD (Blu-Ray Disc (registered trademark)).

### Operation Input Unit

The operation input unit 236 is configured for the user to do operation input. The operation input unit 236 generates a signal in accordance with a user operation and supplies the signal to the system controller 220. The operation input unit 236 may be, for example, an operating unit such as a touch panel, a button, a switch, a lever, or a dial, a light-receiving unit for an infrared signal generated by a remote controller, or a receiving unit of a wireless signal. Further, the operation input unit 236 may be a sensing device such as an acceleration sensor, an angular velocity sensor, a vibration sensor, and a pressure sensor.

### Power Input Unit

The power input unit 240 has commercial power supplied by a commercial power company or privately generated power supplied by the private power generating apparatus 30 input thereto.

### Power Controller

The power controller 244 controls the use of privately generated power, the use of commercial power, the accumulation in the accumulator 40, and the use of power of the accumulator 40 based on commercial power information received by the communication unit 228. As will be described in detail in “2-2. Operation of Power Control Unit According to First Embodiment”, the power controller 244 determines whether the present time is in a peak time zone based on commercial power information so that the use of privately generated power is prioritized in a peak time zone and all or a portion of privately generated power is accumulated in the accumulator 40 while not in a peak time zone.

The method of determining whether the present time is in a peak time zone is not specifically limited. If, for example, the commercial power information indicates the current balance between supply and demand (for example, the ratio of demand to the maximum supply power) of commercial power, the power controller 244 may determine that the present time is in a peak time zone if the balance between supply and demand is larger than a predetermined threshold (for example, 90%).

If the commercial power information is demand forecasting information indicating demand forecasting of commercial power as shown in FIG. 2, the power controller 244 may identify a time zone in which the demand of commercial power or the ratio of the demand to the maximum supply power is larger than a predetermined threshold as a peak time zone. If, for example, the demand forecasting information shown in FIG. 2 is obtained, the power controller 244 may identify the time zone between 13 and 15 in which the demand is expected to exceed 40 million kW as a peak time zone.

If the commercial power information is statistical information of past power demand, the power controller 244 may identify a peak time zone based on the power demand in the same period in the past. For example, the power controller 244 may identify a time zone in which the power demand in the same period a year ago is higher than a predetermined threshold as a peak time zone.

If the commercial power information indicates the peak time zone of power demand, the power controller 244 may determine whether the present time is in a peak time zone indicated by the commercial power information. When alarm information indicating the degree of tightness of power demand is issued as the commercial power information, the power controller 244 may determine that the present time is in the peak time zone.

According to the above determination methods of the peak time zone, it is expected that the time zone between 13 and 15 or so in which the highest temperature is reached in summer is determined to be the peak time zone due to the demand for cooling and the nighttime in which the temperature is low in winter is determined to be the peak time zone due to the demand for heating.

The power controller 244 may determine the peak time zone based on, in addition to the commercial power information, the season, the region, and the outside air temperature. For example, the power controller 244 may determine the peak time zone in the range of daytime when the season is the summer and in the range of nighttime when the season is the winter.

Because the peak of power demand is considered to be reached in a time zone in which the temperature is high due to an increase in demand for cooling or in a time zone in which the temperature is low due to an increase in demand for heating, the power controller 244 may determine the peak time zone within the range of time zones in which the outside air temperature is higher than a high-temperature threshold or within the range of time zones in which the outside air temperature is lower than a low-temperature threshold.

In addition, the timing of occurrence of the power demand peak is different from region to region. For example, in a northern region, the demand for cooling is not high even in summer, but in a southern region, the demand for cooling is high in summer and so the peak of power demand occurs. Thus, the power controller 244 may determine the peak time zone within the range of the season in accordance with the region and time zones. If the private power generating apparatus 30 is a photovoltaic power generator, the outside air temperature is considered to be high when the amount of power generated by the private power generating apparatus 30 is large and the demand for cooling increases in summer. Also, the outside air temperature is considered to be low when the amount of power generated by the private power generating apparatus 30 is small and the demand for heating increases in winter. Therefore, the power controller 244 may determine the peak time zone based on the amount of power generated by the private power generating apparatus 30.

### 2-2. Operation of Power Control Unit According to First Embodiment

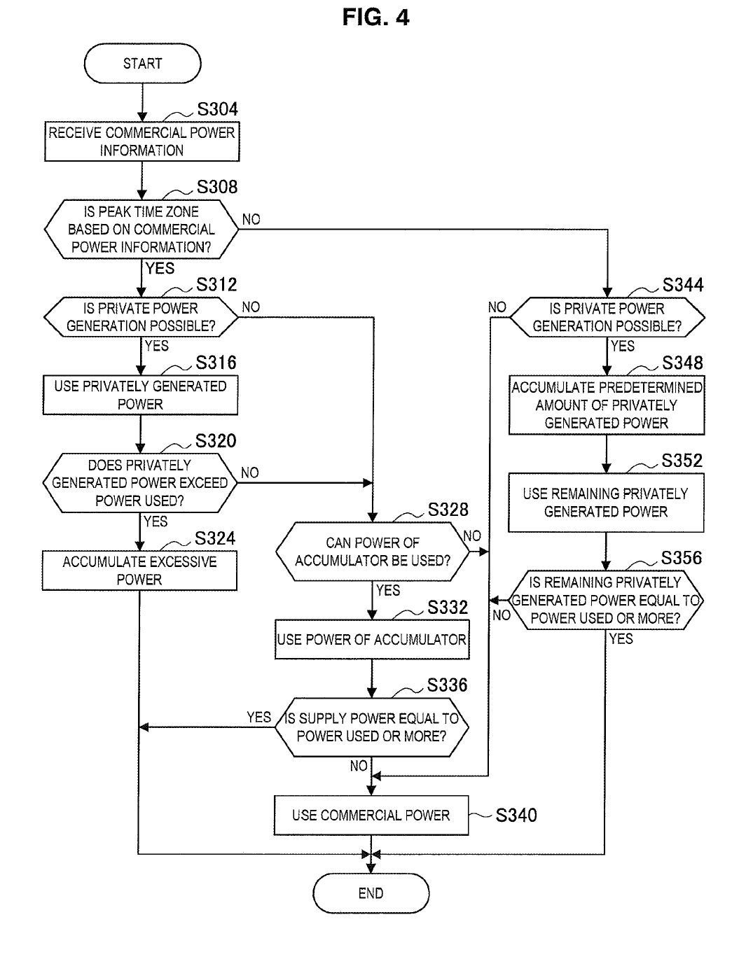

In the foregoing, the configuration of the power control unit 20-1 according to the first embodiment has been described. Subsequently, the operation of the power control unit 20-1 according to the first embodiment will be described with reference to FIG. 4.

FIG. 4 is a flow chart showing the operation of the power control unit 20-1 according to the first embodiment. As shown in FIG. 4, when the communication unit 228 of the power control unit 20-1 receives commercial power information from the power information providing apparatus 10 (S304), the power controller 244 determines whether the present time is in a peak time zone based on the commercial power information (S308).

### Peak Time Zone

If the present time is in a peak time zone and power can privately be generated (S312), the power controller 244 uses, that is, supplies privately generated power supplied by the private power generating apparatus 30 to the electrical apparatus 50 (S316). If the privately generated power exceeds power used by the electrical apparatus 50 (S320), the power controller 244 accumulates excessive power in the accumulator 40. If power cannot privately be generated (S312), the power controller 244 proceeds to the processing in S328.

If, on the other hand, the privately generated power is equal to power used by the electrical apparatus 50 or less, the power controller 244 determines whether power of the accumulator 40 can be used (S328). If power of the accumulator 40 cannot be used, the power controller 244 proceeds to the processing in S340. If power of the accumulator 40 can be used, the power controller 244 uses power of the accumulator 40 (S332).

Further, if supply power (privately generated power and/or power of the accumulator 40) is less than power used by the electrical apparatus 50 (S340), the power controller 244 uses commercial power (S340).

### Outside Peak Time Zone

On the other hand, if the present time is not in a peak time zone and power can privately be generated (S344), the power controller 244 accumulates a predetermined amount of privately generated power in the accumulator 40 (S348). Then, the power controller 244 supplies remaining privately generated power to the electrical apparatus 50 (S352). If remaining privately generated power is less than power used by the electrical apparatus 50 (S356), the power controller 244 uses commercial power (S340). The power controller 244 also uses commercial power when power cannot privately be generated (S344).

### Concrete Application Example

According to the aforementioned operation of the power control unit 20-1, if the private power generating apparatus 30 is a photovoltaic power generator, it is difficult to privately generate a sufficient amount of power in the nighttime or in a rainy day and therefore, the following power control is exercised under each of the following conditions in summer:
Weather: clear
   Peak time zone Use privately generated power and use power of the accumulator 40
   Outside peak time zone (daytime) Use commercial power, accumulate a portion of privately generated power, and use the rest of privately generated power
   Outside peak time zone (nighttime) Use commercial power
Weather: rainy
   Peak time zone Use power of the accumulator 40
   Outside peak time zone (daytime) Use commercial power (partly, the accumulator 40 can also be used) and use the rest of privately generated power
   Outside peak time zone (nighttime) Use commercial power

### Effects of the First Embodiment

According to the first embodiment of the present disclosure, as described above, tightening of power demand with respect to the maximum supply power can be mitigated by appropriately controlling the use of privately generated power, the use of commercial power, the accumulation in the accumulator 40, and the use of power in the accumulator 40 based on commercial power information.

### 3. Second Embodiment

In the foregoing, the first embodiment of the present disclosure has been described. Subsequently, the second embodiment of the present disclosure will be described. If, for example, the private power generating apparatus 30 is a fuel cell, repeating the start and stop of private power generation achieves low generation efficiency because of generation of small power. According to the second embodiment of the present disclosure, by contrast, the efficiency of private power generation can be increased by controlling the start and stop of private power generation in accordance with the remaining power of the accumulator 40.

### 3-1. Configuration of Power Control Unit According to Second Embodiment

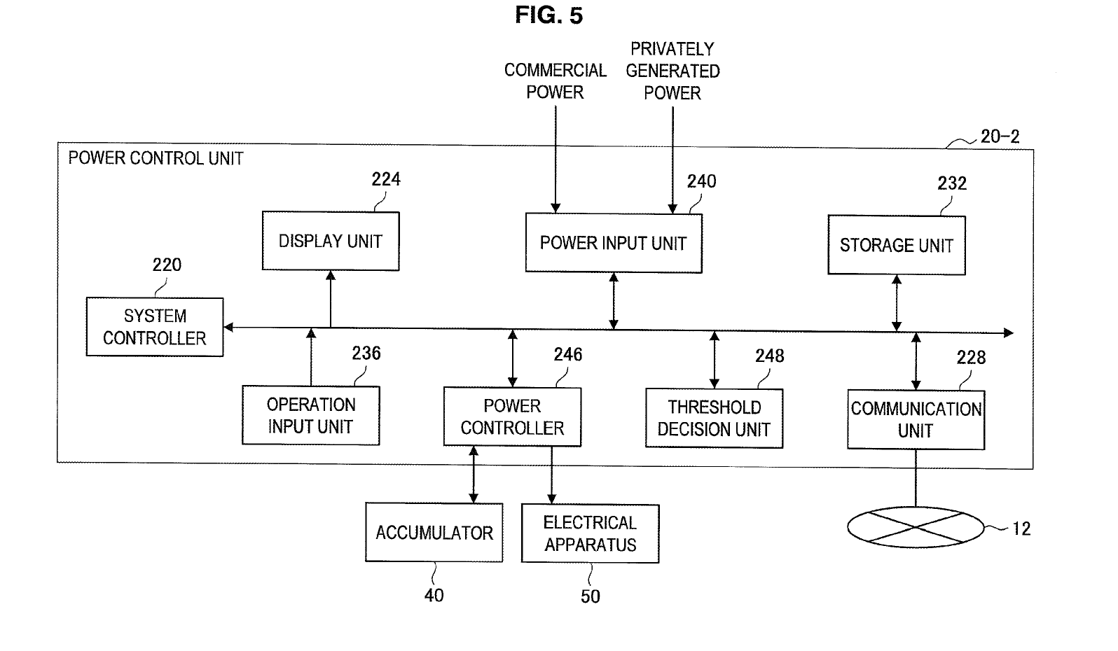

FIG. 5 is a function block diagram showing the configuration of a power control unit 20-2 according to the second embodiment. As shown in FIG. 5, the power control unit 20-2 according to the second embodiment includes the system controller 220, the display unit 224, the communication unit 228, the storage unit 232, the operation input unit 236, the power input unit 240, the power controller 246, and a threshold decision unit 248. The system controller 220, the display unit 224, the communication unit 228, the storage unit 232, the operation input unit 236, and the power input unit 240 are as described in the first embodiment and a detailed description thereof is omitted here.

### Threshold Decision Unit

The threshold decision unit 248 decides a remaining power threshold of the accumulator 40 to start private power generation based on commercial power information received by the communication unit 228. Regarding this point, the speed of consuming power of the accumulator 40 is considered to be fast on a day when the power demand is high and thus, if the timing to start private power generation is late, the accumulator 40 may be dead. Therefore, the threshold decision unit 248 decides the remaining power threshold of the accumulator 40 in accordance with the power demand indicated by the commercial power information.

If, for example, the commercial power information contains demand forecasting information indicating demand forecasting of commercial power, the remaining power threshold may be decided on a decreasing value with decreasing demand forecasting indicated by the demand forecasting information and on an increasing value with increasing demand forecasting indicated by the demand forecasting information. The threshold decision unit 248 may decide the remaining power threshold in units of days or for each time zone. For example, the threshold decision unit 248 may decide the remaining power threshold on an increasing value with increasing power demand forecasting (maximum power demand/maximum power supply in a day) or on an increasing value for a time zone with increasing power demand like the peak time zone. The peak time zone can be determined, as described in the first embodiment, based on the current balance of demand and supply indicated by commercial power information, statistical information of past power demand, peak time zones of power demand, or alarm information, the season, regions, the outside air temperature, or the room temperature (the room temperature when an air conditioner is turned off or in a place less affected by an air conditioner).

### Power Controller

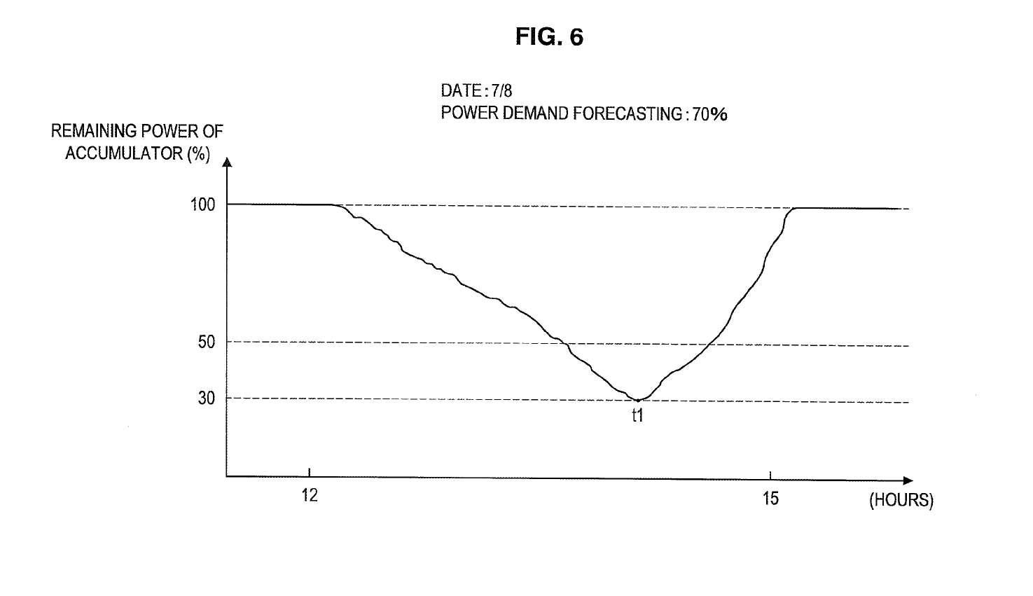

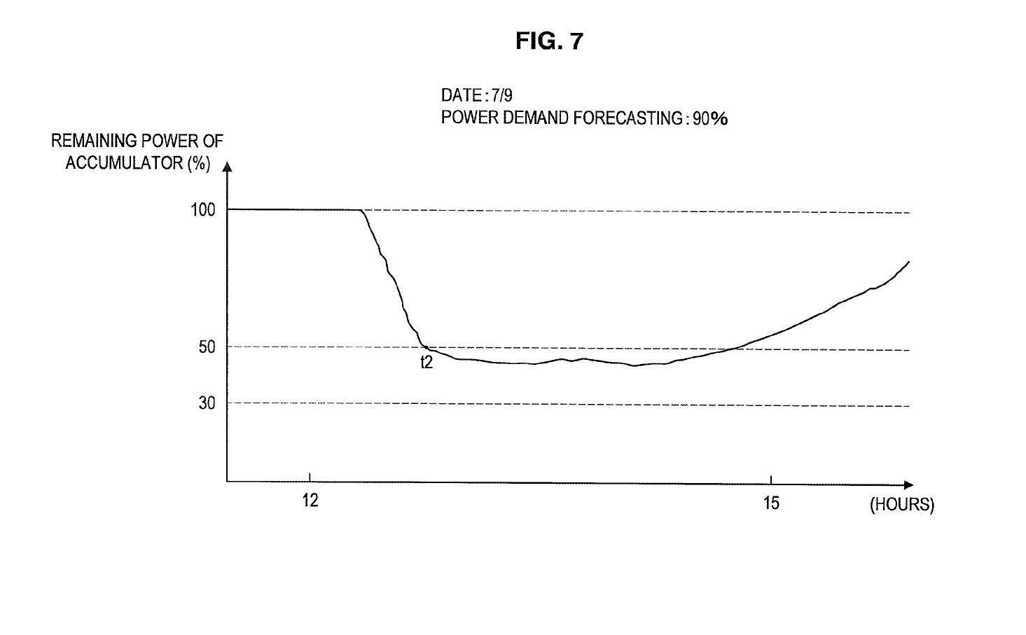

Based on commercial power information received by the communication unit 228, the power controller 246 controls the use of privately generated power, the use of commercial power, the accumulation in the accumulator 40, and the use of power of the accumulator 40. Particularly when remaining power of the accumulator 40 falls below the remaining power threshold decided by the threshold decision unit 248, the power controller 246 according to the second embodiment causes the private power generating apparatus 30 to start private power generation. Incidentally, a control signal to the private power generating apparatus 30 may be transmitted via a dedicated path for control or by PLC (Power Line Communication) via a power supply line. A concrete example of private power generation control by the above power controller 246 will be described below with reference to FIGS. 6 and 7.

FIGS. 6 and 7 are explanatory views showing changes of remaining power of the accumulator 40. More specifically, FIG. 6 shows changes of remaining power of the accumulator 40 on a day on which power demand forecasting (maximum power demand/maximum power supply in a day) is 70% and power demand has enough room and FIG. 7 shows changes of remaining power of the accumulator 40 on a day on which power demand forecasting is 90% and power demand is relatively tight.

The threshold decision unit 248 decides the remaining power threshold for a day on which, as shown in FIG. 6, power demand has enough room on a smaller value than that for a day on which, as shown in FIG. 7, power demand is relatively tight. For example, the threshold decision unit 248 decides the remaining power threshold for a day on which, as shown in FIG. 6, power demand has enough room on 30% and the remaining power threshold for a day on which, as shown in FIG. 7, power demand is relatively tight on 50%.

In this case, the power controller 246 causes the private power generating apparatus 30 to start private power generation at t1 when remaining power of the accumulator 40 falls below 30% on a day on which, as shown in FIG. 6, power demand has enough room. On the other hand, the power controller 246 causes the private power generating apparatus 30 to start private power generation at t2 when remaining power of the accumulator 40 falls below 50% on a day on which, as shown in FIG. 7, power demand is relatively tight.

Therefore, the efficiency of private power generation can be increased by controlling the start and stop of private power generation in accordance with the remaining power of the accumulator 40. In addition, a case when the accumulator 40 becomes dead can be inhibited by deciding the remaining power threshold to start private power generation in accordance with the power demand.

### 3-2. Operation of Power Control Unit According to Second Embodiment

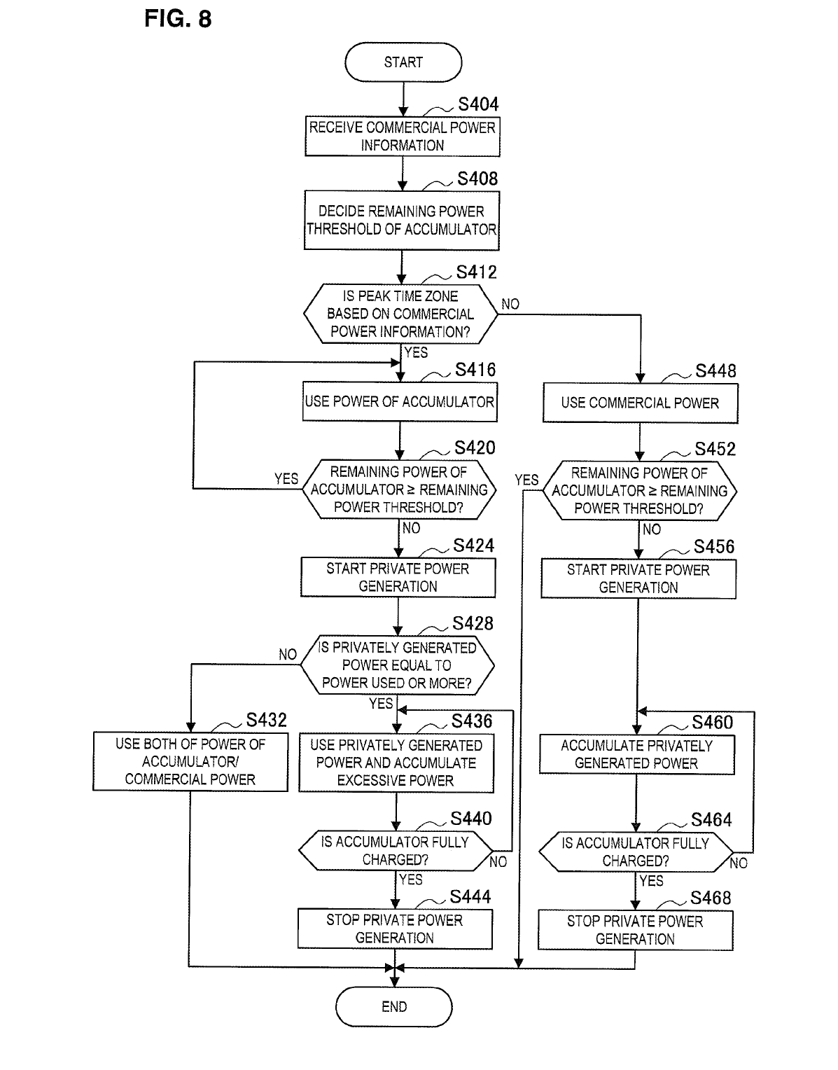

In the foregoing, the configuration of the power control unit 20-2 according to the second embodiment of the present disclosure has been described. Subsequently, the operation of the power control unit 20-2 according to the second embodiment will be described with reference to FIG. 8.

FIG. 8 is a flow chart showing the operation of the power control unit 20-2 according to the second embodiment. As shown in FIG. 8, when the communication unit 228 of the power control unit 20-1 receives commercial power information from the power information providing apparatus 10 (S404), the threshold decision unit 248 decides the remaining power threshold based on the commercial power information (S408). Subsequently, the power controller 244 determines whether the present time is in a peak time zone based on the commercial power information (S412).

### Peak Time Zone

If the present time is in a peak time zone, the power controller 244 uses power of the accumulator 40 (S416). If the remaining power of the accumulator 40 falls below the remaining power threshold (S420), the power controller 244 causes the causes the private power generating apparatus 30 to start private power generation (S424). Then, if the privately generated power is less than power used by the electrical apparatus 50 (S428), the power controller 244 uses both of the privately generated power and power of the accumulator 40 and further uses commercial power if necessary (S432).

On the other hand, if the privately generated power is equal to power used by the electrical apparatus 50 or more (S428), the power controller 244 uses the privately generated power and accumulates excessive power in the accumulator 40 (S436). Then, when the accumulator 40 is fully charged (S440), the power controller 244 causes the causes the private power generating apparatus 30 to stop private power generation (S444).

### Outside Peak Time Zone

If the present time is not in a peak time zone, the power controller 244 uses commercial power (S448). Then, if the remaining power of the accumulator 40 falls below the remaining power threshold (S452), the power controller 244 causes the private power generating apparatus 30 to start private power generation (S456). Because the speed of consuming power by the electrical apparatus 50 is considered to be slower outside a peak time zone than in a peak time zone, the remaining power threshold outside a peak time zone may be larger than that in a peak time zone.

Then, the power controller 244 accumulates privately generated power in the accumulator 40 (S460) and when the accumulator 40 is fully charged (S464), causes the private power generating apparatus 30 to stop private power generation (S468).

### 4. Summary

According to the first embodiment of the present disclosure, as described above, tightening of power demand with respect to the maximum supply power can be mitigated by appropriately controlling the use of privately generated power, the use of commercial power, the accumulation in the accumulator 40, and the use of power in the accumulator 40 based on commercial power information. For a commercial power company, power demand at peak is reduced and so stable power supply can be realized even if the maximum supply power is limited.

In addition, according to the second embodiment of the present disclosure, the efficiency of private power generation can be increased by controlling the start and stop of private power generation in accordance with remaining power of the accumulator 40. In addition, a case when the accumulator 40 becomes dead can be inhibited by deciding the remaining power threshold to start private power generation in accordance with the power demand.

The preferred embodiments of the present disclosure have been described above with reference to the accompanying drawings, whilst the present disclosure is not limited to the above examples, of course. A person skilled in the art may find various alterations and modifications within the scope of the appended claims, and it should be understood that they will naturally come under the technical scope of the present disclosure.

For example, each step of processing by the power control unit 20 herein does not have to be performed chronologically in the order described as a flow chart. For example, each step of processing by the power control unit 20 may be performed in an order that is different from the order described as a flow chart or in parallel.

Also, a computer program causing hardware such as a CPU, a ROM, a RAM and the like contained in the power control unit 20 to execute a function equivalent to that of each component of the aforementioned power control unit 20 can be created. In addition, a storage medium caused to store the computer program is provided.

Additionally, the present technology may also be configured as below.

(1)

A power control unit including:
a receiving unit that receives information about commercial power; and
a control unit that controls use of power generated by private power generation and use of the commercial power in accordance with the information received by the receiving unit.
   (2)

The power control unit according to (1), wherein the control unit further controls whether to perform the private power generation in accordance with the information received by the receiving unit.

(3)

The power control unit according to (2), wherein, when remaining power of an accumulator that accumulates the power by the private power generation falls below a remaining power threshold decided based on the information received by the receiving unit, the control unit controls a start of the private power generation and accumulates excessive power of the private power generation in the accumulator.

(4)

The power control unit according to (3),
wherein the information about the commercial power contains demand forecasting information indicating demand forecasting of the commercial power, and
wherein the control unit decides the remaining power threshold on a lower value with decreasing demand forecasting indicated by the demand forecasting information.
   (5)

The power control unit according to (3),
wherein the information about the commercial power contains demand forecasting information indicating demand forecasting of the commercial power, and
wherein the control unit decides the remaining power threshold on an higher value with increasing demand forecasting indicated by the demand forecasting information.
   (6)

The power control unit according to (3), wherein, when demand of the commercial power exceeds predetermined criteria, the information about the commercial power contains alarm information.

(7)

The power control unit according to any one of (1) to (6), wherein the control unit determines whether a present time is in a peak time zone of power demand and prioritizes the use of the power by the private power generation in the peak time zone and the use of the commercial power outside the peak time zone.

(8)

The power control unit according to (7),
wherein the information about the commercial power contains power demand information about demand in each time zone of the commercial power provided by a commercial power company, and
wherein the control unit determines the peak time zone based on the power demand information.
   (9)

The power control unit according to (8), wherein the power demand information indicates a current balance of demand and supply of the commercial power.

(10)

The power control unit according to (8), wherein the power demand information is demand forecasting information indicating demand forecasting of the commercial power.

(11)

The power control unit according to (8), wherein the power demand information is statistical information of past power demand.

(12)

The power control unit according to any one of (8) to (11), wherein the control unit determines the peak time zone further based on a season.

(13)

The power control unit according to any one of (8) to (12), wherein the control unit determines the peak time zone further based on an outside air temperature or a room temperature.

(14)

The power control unit according to any one of (8) to (13), wherein the control unit determines the peak time zone further based on an amount of power generated by the private power generation.

(15)

A program causing a computer to function as a receiving unit that receives information about commercial power and a control unit that controls use of power generated by private power generation and use of the commercial power in accordance with the information received by the receiving unit.

### REFERENCE SIGNS LIST

10 power information providing apparatus
12 communication network
20 power control unit
30 private power generating apparatus
40 accumulator
50 electrical apparatus
220 system controller
224 display unit
228 communication unit
232 storage unit
236 operation input unit
240 power input unit
244, 246 power controller
248 threshold decision unit
252, 254 power controller

1. A power control unit comprising:
a receiving unit that receives information about commercial power; and
a control unit that controls use of power generated by private power generation and use of the commercial power in accordance with the information received by the receiving unit.

2. The power control unit according to claim 1, wherein the control unit further controls whether to perform the private power generation in accordance with the information received by the receiving unit.

3. The power control unit according to claim 2, wherein, when remaining power of an accumulator that accumulates the power by the private power generation falls below a remaining power threshold decided based on the information received by the receiving unit, the control unit controls a start of the private power generation and accumulates excessive power of the private power generation in the accumulator.

4. The power control unit according to claim 3,
wherein the information about the commercial power contains demand forecasting information indicating demand forecasting of the commercial power, and
wherein the control unit decides the remaining power threshold on a lower value with decreasing demand forecasting indicated by the demand forecasting information.

5. The power control unit according to claim 3,
wherein the information about the commercial power contains demand forecasting information indicating demand forecasting of the commercial power, and
wherein the control unit decides the remaining power threshold on an higher value with increasing demand forecasting indicated by the demand forecasting information.

6. The power control unit according to claim 3, wherein, when demand of the commercial power exceeds predetermined criteria, the information about the commercial power contains alarm information.

7. The power control unit according to claim 1, wherein the control unit determines whether a present time is in a peak time zone of power demand and prioritizes the use of the power by the private power generation in the peak time zone and the use of the commercial power outside the peak time zone.

8. The power control unit according to claim 7,
wherein the information about the commercial power contains power demand information about demand in each time zone of the commercial power provided by a commercial power company, and
wherein the control unit determines the peak time zone based on the power demand information.

9. The power control unit according to claim 8, wherein the power demand information indicates a current balance of demand and supply of the commercial power.

10. The power control unit according to claim 8, wherein the power demand information is demand forecasting information indicating demand forecasting of the commercial power.

11. The power control unit according to claim 8, wherein the power demand information is statistical information of past power demand.

12. The power control unit according to claim 8, wherein the control unit determines the peak time zone further based on a season.

13. The power control unit according to claim 8, wherein the control unit determines the peak time zone further based on an outside air temperature or a room temperature.

14. The power control unit according to claim 8, wherein the control unit determines the peak time zone further based on an amount of power generated by the private power generation.

15. A program causing a computer to function as a receiving unit that receives information about commercial power and a control unit that controls use of power generated by private power generation and use of the commercial power in accordance with the information received by the receiving unit.
